(19) United States
(12) Patent Application Publication
(10) Pub. No.: US 2007/0056528 A1
(43) Pub. Date: Mar. 15, 2007

(54) Combined leash and umbrella

(76) Inventor: Jason Schwartz, East Brunswick, NJ (US)

Correspondence Address: Ladas & Parry LLP, 26 West 61 Street, New York, NY, 10023, US

(21) Appl. No.: 11/475,562

(22) Filed: Jun. 27, 2006

Related U.S. Application Data
(60) Provisional application No. 60/694,934, filed on Jun. 28, 2005.

(51) Int. Cl. A01K 27/00

(52) U.S. Cl. 119/796

(57) ABSTRACT

A combined leash and umbrella has a cover that opens over shaft and handle to provide protection for a user, and a leash connected to the handle. In a preferred embodiment, the handle includes a leash-retracting mechanism and enables a one-hand operation of the umbrella and a retractable leash.

### CROSS REFERENCE TO RELATED APPLICATIONS

This application claims the benefit of provisional application No. 60/694,934 filed on Jun. 28, 2005, which is hereby incorporated by reference.

### FIELD OF THE INVENTION

This application relates to a combined leash and umbrella.

### BACKGROUND AND PRIOR ART

People frequently use a leash when walking a pet. This is particularly common in urban areas with leash laws that require a pet, such as a dog, to be on a leash at all times in public areas.

There are many types of leashes. One type simply consists of a fixed length rope or chain, which may be wrapped around the user's hand or arm to vary the length of the leash from the user to the pet. Another type of leash includes a mechanism for retracting and releasing the leash, and a handle having a control for locking the retractable leash.

When it rains or snows, a pet-walker will usually take an umbrella to protect himself. Some pet-walkers may also take an umbrella to protect against the sun or other elements of weather.

When using an umbrella, both hands of the pet-walker are usually occupied: one hand holding the umbrella, the other hand holding the leash. Two hands are particularly required when using an umbrella and a retractable leash. This is both awkward and strenuous on the pet-walker's hands, and is inconvenient as it leaves no free hand for the pet-walker to, for example, hold a brief case, use a mobile-phone, or smoke.

U.S. Pat. No. 7,036,519 discloses a combination leash and umbrella device. The device includes a post to be held at one end, and connected at the opposite to an umbrella that opens over a leash attached to the inside of the umbrella end. As the umbrella opens over the animal, no protection is provided to the user. Consequently, if used in the rain, a user who wishes to use an umbrella must hold a second one. Furthermore, the leash is attached to the inside of the umbrella, and thus the leash cannot be adjusted or operated by the user when holding the handle.

U.S. Pat. No. 6,871,616 discloses a similar combination leash and umbrella device. The device includes an umbrella that opens over the animal only, and the leash cannot be adjusted or operated by the user when holding the handle.

### SUMMARY OF THE INVENTION

The present invention provides a leash and umbrella device, which provides protection for the user and can be operated by one hand.

In a preferred embodiment, the handle of the leash and umbrella device includes a leash-retracting mechanism.

In another preferred embodiment, the leash-retracting mechanism includes a spring-biased reel.

In another preferred embodiment, the handle further includes a stopping mechanism for stopping the leash from being retracted.

The handle may also include a control button operably connected to the stopping mechanism to actuate the stopping mechanism.

In another preferred embodiment, the handle is dimensioned to house the leash-retracting mechanism inside the handle.

In another preferred embodiment, the retractable leash mechanism is detachable from the device to form separate umbrella and leash.

The present invention also provides an umbrella including a shaft having a hand engagement portion for a user and a leash connected to the hand engagement portion whereby the user is able to hold the umbrella in an operative state to protect the user against rain while engaging the leash to control an animal attached thereto.

### BRIEF DESCRIPTION OF THE FIGURES OF THE DRAWING

FIG. 1 shows a preferred embodiment of the invention in which the combined leash and umbrella is in an opened position.

FIG. 2 shows the embodiment of FIG. 1 in a closed position.

FIG. 3 is a sectional view along line 3-3 of FIG. 2.

FIG. 4 shows a user using the combined leash and umbrella with a dog.

### DETAILED DESCRIPTION

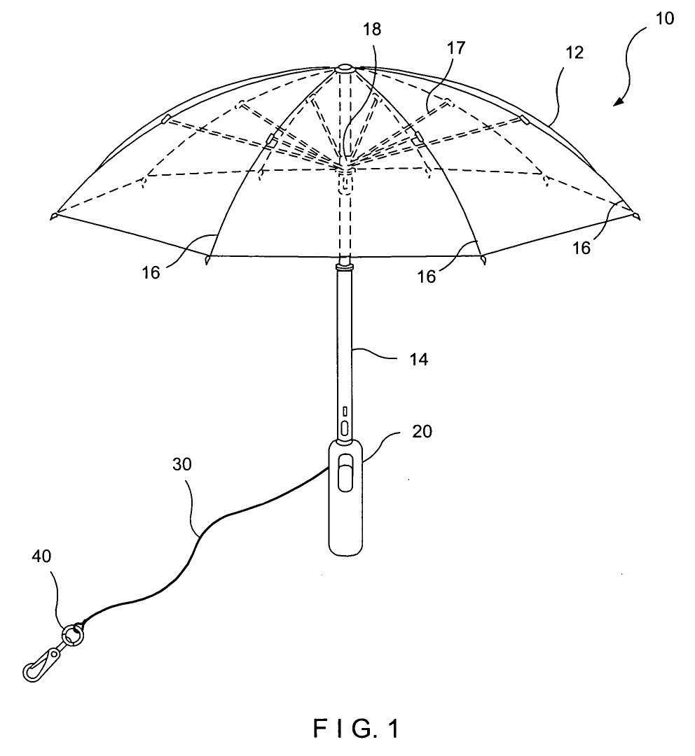

FIG. 1 shows a preferred embodiment of a combined animal leash and umbrella. The umbrella 10 includes a shaft 14 having two ends. Mounted to one end of the shaft 14 are support ribs 16 to which a cover 12 is attached. The opposite end of the shaft 14 is connected to a handle 20. A leash 30 is secured to the handle 20 at one end, and at another end the leash is connected to a hook 40 for attachment to a collar or harness of an animal. Those skilled in the art will recognize that various means for securing the leash to the animal may be used, such as snap hooks, spring hooks, trigger hooks, S hooks, quick-release hooks, links, clips, chains, buckles, snap closures, and latches. (As used in the specification and claims, “securing the leash to an animal” means securing the leash to some article on an animal, such as a collar or harness.)

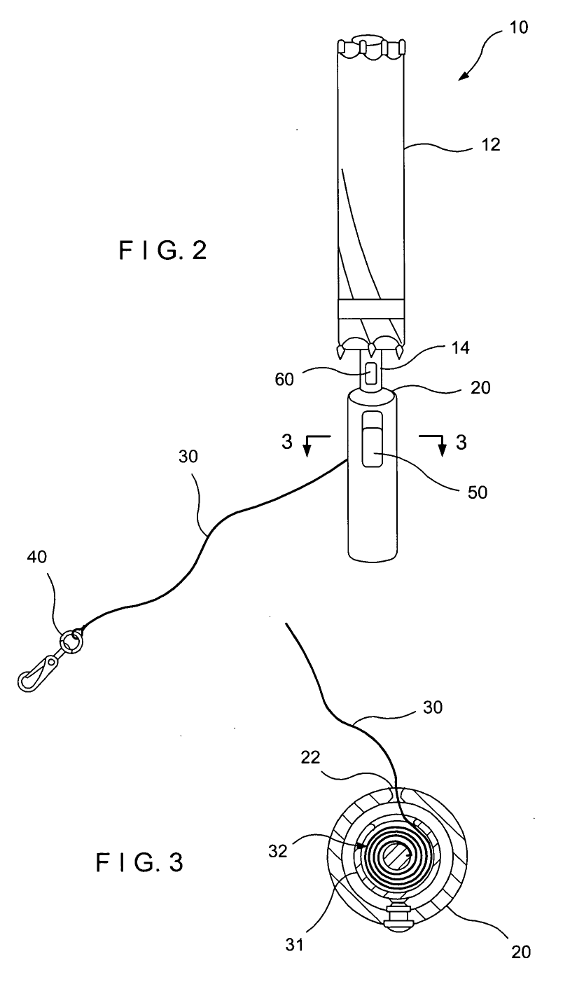

The support ribs 16 may be connected to stretchers 17 that are connected to a runner 18 having a center hole. The runner 18 may move slidably along the shaft 14 between an open position shown in FIG. 1 and a closed position shown in FIG. 2, and which enables the cover 12, support ribs 16, the stretchers 17, and shaft 14 of the umbrella to be folded and/or collapsed.

It is noted that the umbrella 10 opens to the position shown in FIG. 1 to provide a shield above and over the user.

The umbrella 10 may include a control button 60, which controls a latch or locking member to retain the umbrella in the closed position. The user may press the umbrella control button 60 to unfold or expand the support ribs 16 and the cover 12 to open the umbrella 10. The umbrella may also include an elastic means that urges and keeps the umbrella in the open position and/or an additional latch or lock mechanism that maintains the umbrella in the open position.

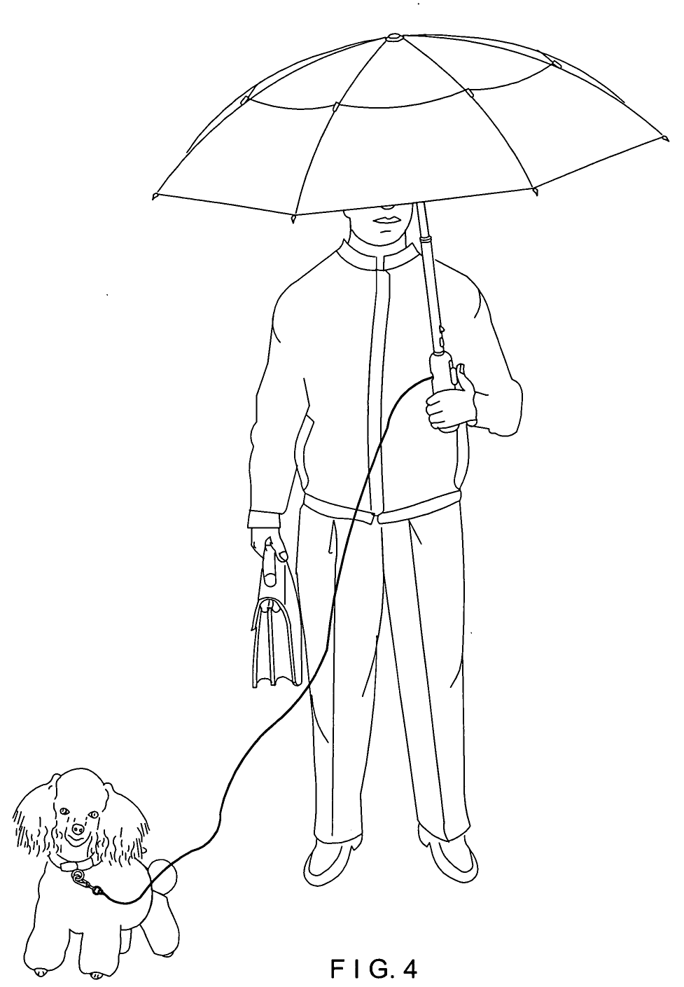

The handle 20 of the umbrella 10 may be provided with a leash-retracting mechanism that enables adjustment of the length of the leash 30. The leash-retracting mechanism can be any conventional means for releasing or retracting a leash, a rope, or a string. For example, as shown in FIG. 3, the handle 20 has a storage chamber 31 that houses a leash-retracting mechanism having a spool 32 of leash 30 wound on a spring-biased reel. The leash 30 enters and exits the handle through an opening 22. The spring-biased reel is biased to retract the leash 30. The leash 30 may be extended when the tension on the leash 30 overcomes the spring bias of the reel.

The leash-retracting mechanism may further include a stopping mechanism to lock and stop the leash from being extended or retracted. In the preferred embodiment shown in FIGS. 1 and 2, the handle 20 is provided with a button 50 which can slide between a first position in which the leash-retracting mechanism is free to retract or extend as described above, and a second position in which the button actuates a stopping mechanism and locks the leash at a length.

In a preferred embodiment, the length of the retractable leash is approximately 55 inches long.

In another preferred embodiment, the handle includes two detachable portions. One of the portion is connected to shaft 14 of the umbrella, and the other portion is a detachable portion housing the leash-retracting mechanism. When the two portions are detached, separate umbrella and leash, which can each be operated separately, are formed.

FIG. 4 shows the combined umbrella and leash in use by a user with a dog.

Although the invention is disclosed with reference to particular embodiments thereof, it will become apparent to those skilled in the art that numerous modifications and variations can be made which will fall within the scope and spirit of invention as defined by the attached claims. For example, although the umbrella cover is shown as a single canopy having a convex shape, many configurations and shapes may be utilized. The umbrella may be of different sizes or forms, such as pocket-size umbrellas, parasols, golf umbrellas, beach umbrellas, or doorman's umbrellas. Many other shapes may also be used for the handle, such as a “Prince of Whales” (J-shape) or “golf stick.” Furthermore, although the operation of the invention has been described with reference to a pet or a dog, it will become apparent to those skilled in the art that the combined leash and umbrella may be adapted for use with any animal that may be put on a leash.

1. A leash and umbrella device comprising:
a shaft;
a plurality of support ribs mounted on one end of the shaft;
a cover mounted on the support ribs;
a handle connected to an opposite end of the shaft;
a leash having one end secured to the handle; and
securing means attached to an opposite end of the leash for securing the leash to an animal.

2. The device according to claim 1, wherein the leash is fixedly secured to the handle.

3. The device according to claim 1, wherein the leash is retractably secured to the handle.

4. The device according to claim 1, wherein the handle comprises a leash-retracting mechanism.

5. The device according to claim 4, wherein the leash-retracting mechanism comprises a spring-biased reel.

6. The device according to claim 4, wherein the handle further comprises a stopping mechanism for stopping the leash from being retracted.

7. The device according to claim 6, wherein the handle further comprises a control button operably connected to the stopping mechanism to actuate the stopping mechanism.

8. The device according to claim 4, wherein the handle is dimensioned to house the leash-retracting mechanism inside the handle.

9. The device according to claim 4, wherein the leash-retracting mechanism comprises means for winding and retracting the leash on a spool.

10. The device according to claim 4, wherein the leash-retracting mechanism is detachable.

11. An umbrella comprising a shaft having a hand engagement portion for a user and a leash connected to the hand engagement portion whereby the user is able to hold the umbrella in an operative state to protect the user while engaging the leash.
